(19) United States
(12) Patent Application Publication
(10) Pub. No.: US 2025/0244633 A1
(43) Pub. Date: Jul. 31, 2025

(54) OPTICAL MODULATOR, LIGHT SOURCE MODULE, OPTICAL ENGINE, AND XR GLASSES

(71) Applicant: TDK Corporation, Tokyo (JP)

(72) Inventors: Hiroki HARA, Tokyo (JP); Yasuhiro TAKAGI, Tokyo (JP)

(73) Assignee: TDK Corporation, Tokyo (JP)

(21) Appl. No.: 18/985,316

(22) Filed: Dec. 18, 2024

(30) Foreign Application Priority Data
Jan. 30, 2024 (JP) 2024-011771

(51) Int. Cl. G02F 1/21; G02B 26/08; G02B 27/01; G02F 1/225

(52) U.S. Cl. CPC G02F 1/212; G02F 1/2255; G02B 26/0816; G02B 27/0172; G02B 2027/0178

(57) ABSTRACT

An optical modulator includes a substrate, an optical waveguide layer having a Mach-Zehnder waveguide including first and second ridge waveguides propagating visible light, and made of lithium niobate, a buffer layer formed on the optical waveguide layer, a signal electrode formed on buffer layer, and first and second ground electrodes. The signal electrode and first ridge waveguide are arranged so that a distance in a horizontal direction between a center of the signal electrode in a width direction and a center of the first ridge waveguide in the width direction is 0.5 μm or less. The second ground electrode and second ridge waveguide are arranged so that a distance in the horizontal direction between a side surface closer to the second ridge waveguide between two side surfaces of the second ground electrode and a center of the second ridge waveguide in the width direction is 2 μm or less.

### CROSS-REFERENCE TO RELATED APPLICATION

Priority is claimed on Japanese Patent Application No. 2024-011771, filed Jan. 30, 2024, the content of which is incorporated herein by reference.

### BACKGROUND OF THE INVENTION

### Field of the Invention

The present invention relates to an optical modulator, a light source module, an optical engine, and XR glasses.

### Description of Related Art

In recent years, a light source module having an optical modulator to which light is input from a laser diode (a semiconductor laser) has attracted attention. This light source module can be used in optical engines in glasses-type terminals such as XR glasses such as augmented reality (AR) glasses and virtual reality (VR) glasses, small projectors, and the like.

For example, an image display device including a light source portion configured to output first light and second light, an optical modulator having a modulation portion of a Mach-Zehnder-type modulation method, and an optical scanner configured to spatially scan the first light and the second light optically modulated by the optical modulator is described in Patent Document 1. Moreover, as described in Patent Document 1, a head-mounted display is attached to a user's head as an image display device.

Moreover, in Patent Document 2, a transmitting device including a laser light source configured to output visible light and an optical modulator configured to generate a visible light signal by changing an intensity of the visible light is disclosed. As disclosed in Patent Document 2, a Mach-Zehnder-type optical modulator includes a substrate, an optical waveguide layer, a buffer layer, and an electrode layer, wherein the optical waveguide layer includes a lithium niobate film. Moreover, as disclosed in Patent Document 2, a first signal electrode, a second signal electrode, a first ground electrode, a second ground electrode, and a third ground electrode are used as the electrode layer of the optical modulator. The optical modulator disclosed in Patent Document 2 is a so-called dual-drive optical modulator having two signal electrodes.

### PATENT DOCUMENTS

[Patent Document 1] Japanese Patent No. 6728596
[Patent Document 2] Japanese Unexamined Patent Application, First Publication No. 2022-036928

### SUMMARY OF THE INVENTION

In order to popularize glasses-type image display devices such as XR glasses, miniaturization and a low drive voltage are essential. Moreover, for mass production, it is necessary to perform a manufacturing process at the lowest cost possible.

An objective of the present disclosure is to provide an optical modulator for visible light, a light source module, an optical engine equipped with the light source module, and XR glasses capable of being driven at a low voltage in a small size.

To achieve the above-described objective, the following means are provided.

According to aspect 1 of the present disclosure, there is provided an optical modulator including: a substrate; an optical waveguide layer formed on the substrate, having a Mach-Zehnder waveguide including a first ridge waveguide and a second ridge waveguide propagating visible light, and made of lithium niobate; a buffer layer formed on the optical waveguide layer; a signal electrode formed on the buffer layer; and a first ground electrode and a second ground electrode arranged on both sides of the signal electrode, wherein the signal electrode is arranged above the first ridge waveguide, wherein the second ground electrode is arranged above the second ridge waveguide, wherein the signal electrode and the first ridge waveguide are arranged to be relatively shifted so that a distance in a horizontal direction between a center of the signal electrode in a width direction and a center of the first ridge waveguide in the width direction is 0.5 μm or less, and wherein the second ground electrode and the second ridge waveguide are arranged so that a distance in a horizontal direction between a side surface closer to the second ridge waveguide between two side surfaces of the second ground electrode and a center of the second ridge waveguide in the width direction is 2 μm or less.

According to aspect 2 of the present disclosure, in the optical modulator of aspect 1, a dielectric constant of the buffer layer is 7 or more, and a thickness of the buffer layer is 0.4 μm or more and 1 μm or less.

According to aspect 3 of the present disclosure, there is provided a light source module including: the optical modulator according to aspect 1 or 2; and a light source configured to output visible light to be input to the input waveguide of the optical modulator.

According to aspect 4 of the present disclosure, there is provided an optical engine including: the light source module according to aspect 3; and an optical scanning mirror configured to reflect light output from the light source module by changing an angle so that an image is displayed.

According to aspect 5 of the present disclosure, there are provided XR glasses equipped with the optical engine according to aspect 4.

According to the optical modulator of the present disclosure, an optical modulator for visible light capable of being driven at a low voltage in a small size can be provided.

### BRIEF DESCRIPTION OF THE DRAWINGS

FIG. 1 is an explanatory schematic plan view showing an example of an optical modulator of an embodiment.

FIG. 2 is a schematic cross-sectional view in which the optical modulator shown in FIG. 1 is cut along line A-A′ shown in FIG. 1.

FIG. 3 shows a configuration in which a centerline of a first ridge waveguide is shifted to the right with respect to a centerline of a signal electrode.

FIG. 4 is a graph showing a relationship of a relative shift Doc between the signal electrode and a first ridge waveguide and electric field efficiency VπL.

FIG. 5A is a diagram in which configurations of cases where a relative shift D_{CC} is −0.5 μm, 0 μm, and +0.5 μm are depicted in an overlapping manner in a configuration in which a width (Wₑ) of the signal electrode is 1.0 μm.

FIG. 5B is a diagram in which configurations of cases where a relative shift D_{CC} is −0.5 μm, 0 μm, and +0.5 μm are depicted in an overlapping manner in a configuration in which the width (Wₑ) of the signal electrode is 2.0 μm.

FIG. 5C is a diagram in which configurations of cases where a relative shift D_{CC} is −0.5 μm, 0 μm, and +0.5 μm are depicted in an overlapping manner in a configuration in which the width (Wₑ) of the signal electrode is 3.0 μm.

FIG. 6 is a graph showing a relationship between a dielectric constant of a dielectric constituting a buffer layer and the electric field efficiency VπL obtained by simulating red light having a wavelength of 638 nm when the width (Wₑ) of the signal electrode is 3 μm.

FIG. 7 is a graph showing a relationship between a thickness (T_{buffer}) of a buffer layer and the electric field efficiency VπL obtained by simulating red light having a wavelength of 638 nm when the width (Wₑ) of the signal electrode is 3 μm.

FIG. 8 is a graph showing a relationship between a thickness (T_{buffer}) of the buffer layer obtained by simulating red light having a wavelength of 638 nm when the width (Wₑ) of the signal electrode is 3 μm and propagation loss (PL) due to light absorption by the electrode.

FIG. 9 shows a schematic plan view of a light source module according to an embodiment of the present disclosure.

FIG. 10 is a schematic cross-sectional view in which a part of the light source module shown in FIG. 9 is cut on an XZ plane and only a part near a junction portion is depicted.

FIG. 11A is an explanatory diagram showing an example of a drive method of an optical modulator.

FIG. 11B is an explanatory diagram showing another example of the drive method of the optical modulator.

FIG. 11C is an explanatory diagram showing yet another example of the drive method of the optical modulator.

FIG. 12 is an explanatory conceptual diagram showing an example of XR glasses of the present disclosure.

FIG. 13 is a conceptual diagram showing a state in which an image is projected directly onto a retina by a laser beam output from a light source module in the XR glasses shown in FIG. 12.

### DETAILED DESCRIPTION OF THE INVENTION

Hereinafter, the present embodiments will be described in detail with reference to the drawings as appropriate. In the drawings used in the following description, featured parts may be enlarged for convenience so that the features of the present disclosure are easier to understand, and dimensional ratios and the like of the respective components may be different from actual ones. Materials, dimensions, and the like exemplified in the following description are examples, the present disclosure is not limited thereto, and modifications can be appropriately made in a range in which advantageous effects of the present disclosure are exhibited.

### [Optical Modulator]

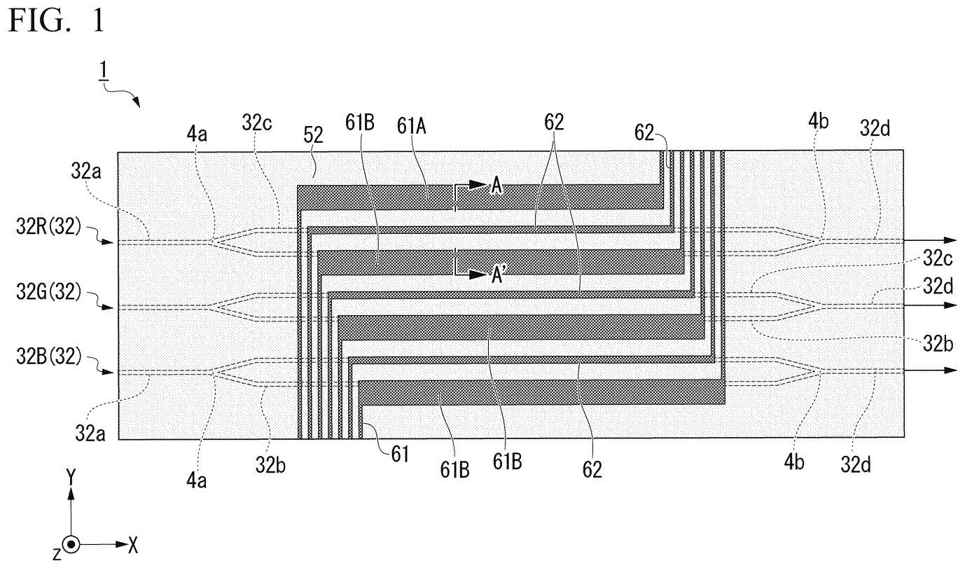

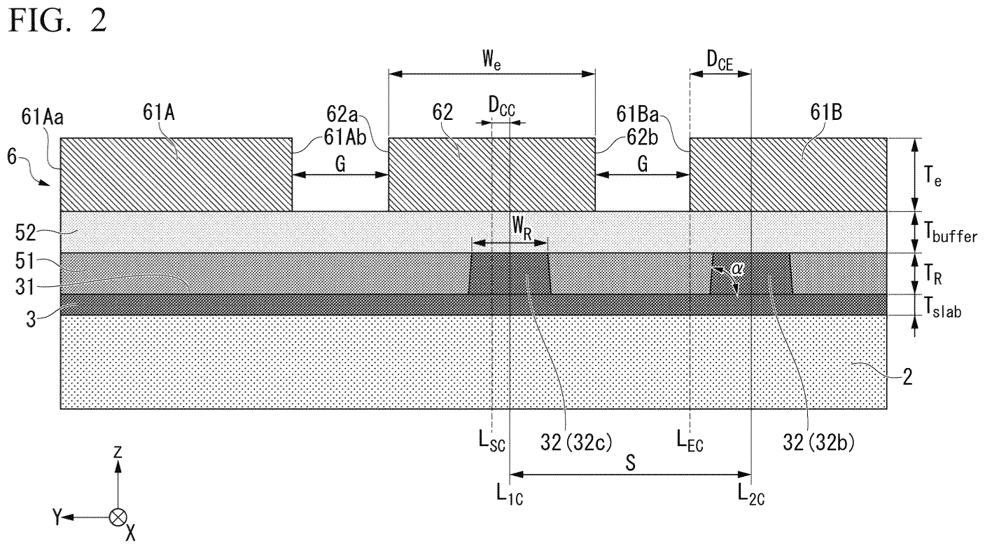

FIG. 1 is an explanatory schematic plan view showing an example of an optical modulator according to an embodiment of the present disclosure. FIG. 2 is a schematic cross-sectional view in which the optical modulator shown in FIG. 1 is cut along line A-A′ shown in FIG. 1.

In FIGS. 1 and 2, an X-direction is a direction orthogonal to a side surface on which a light input port is arranged, a Y-direction is a direction orthogonal to the X-direction, and a Z-direction is a direction perpendicular to surfaces formed in the X-direction and the Y-direction.

The optical modulator of the present embodiment is a Mach-Zehnder interferometer (MZI) type optical modulator.

An optical modulator 1 shown in FIGS. 1 and 2 includes a substrate 2, an optical waveguide layer 3 formed on the substrate 2, having a Mach-Zehnder waveguide including a first ridge waveguide 32c and a second ridge waveguide 32b propagating visible light, and made of lithium niobate, a buffer layer 52 formed on the optical waveguide layer 3, a signal electrode 62 formed on the buffer layer 52, and a first ground electrode 61A and a second ground electrode 61B arranged on both sides of the signal electrode 62. The signal electrode 62 is arranged above the first ground electrode 61A. The second ground electrode 61B is arranged above the second ridge waveguide 32b. The signal electrode 62 and the first ridge waveguide 32c are arranged to be relatively shifted so that a distance in a horizontal direction between a center of the signal electrode 62 in a width direction and a center of the first ridge waveguide 32c in the width direction is 0.5 μm or less. The second ground electrode 61B and the second ridge waveguide 32b are arranged so that a distance in a horizontal direction between a side surface 61Ba closer to the second ridge waveguide 32b between two side surfaces of the second ground electrode 61B and a center of the second ridge waveguide 32b in the width direction is 2 μm or less.

The optical modulator of the present embodiment can be driven at a low voltage in a small size. VπL can be used to evaluate miniaturization and a low drive voltage. Vπ is a voltage required for half-wavelength phase modulation (a half-wavelength voltage) and is defined by a difference between a voltage V₁ at which an optical output is maximized and a voltage V₂ at which the optical output is minimized. Moreover, L denotes a length of the phase modulation region (an interaction length or an electrode length), which is a length of a portion where the signal electrode overlaps an optical waveguide (a ridge portion). The half-wavelength voltage Vπ decreases when the interaction length L increases and the half-wavelength voltage Vπ increases when the interaction length L decreases. When the size of the optical modulator is desired to be reduced, the interaction length Lis shortened and the half-wavelength voltage Vπ is increased.

A smaller VπL indicates a smaller size and a lower drive voltage. Hereinafter, VπL may be referred to as electric field efficiency.

### (Substrate 2)

It is only necessary for the substrate 2 to have a lower refractive index than the lithium niobate film forming the optical waveguide layer 3, the substrate 2 is not particularly limited, and examples of the substrate 2 can include a sapphire substrate, a Si substrate, a thermally oxide silicon substrate, and the like. The substrate 2 is preferably one in which a lithium niobate film can be formed as an epitaxial film.

Because the optical waveguide layer is made of a lithium niobate (LiNbO₃) film, it is not particularly limited as long as the refractive index is lower than that of the lithium niobate film. As a substrate in which a single-crystal lithium niobate film can be formed as the epitaxial film, a sapphire single-crystal substrate or a silicon single-crystal substrate is preferable. The crystal orientation of the single-crystal substrate is not particularly limited. For example, because a c-axis oriented lithium niobate film has three-fold symmetry, the underlying single-crystal substrate also preferably has the same symmetry. In the case of a sapphire single-crystal substrate, a c-plane substrate is preferable. In the case of a silicon single-crystal substrate, a (111) plane substrate is preferable.

### (Optical Waveguide Layer 3)

The optical waveguide layer 3 is made of a lithium niobate film. Lithium niobate forming the lithium niobate film may include elements other than lithium (Li), niobium (Nb), and oxygen (O).

The lithium niobate may be, for example, a compound represented by the following Expression (I).

LixNbAyOz (I)
(In Expression (I), A denotes an element other than Li, Nb, and O. x denotes a number of 0.5 or more and 1.2 or less. y denotes a number of 0 or more and 0.5 or less. z denotes a number of 1.5 or more and 4.0 or less.)

In Expression (I), it is only necessary for A to be an element other than Li, Nb, and O. Examples of A can include K, Na, Rb, Cs, Be, Mg, Ca, Sr, Ba, Ti, Zr, Hf, V, Cr, Mo, W, Fe, Co, Ni, Zn, Sc, Ce, and the like. A may be only one, two, or more selected from these elements.

In Expression (I), x denotes a number of 0.5 or more and 1.2 or less, preferably a number of 0.9 or more and 1.05 or less. y denotes a number of 0 or more and 0.5 or less. z denotes a number of 1.5 or more and 4.0 or less, preferably a number of 2.5 or more and 3.5 or less.

The lithium niobate film forming the optical waveguide layer 3 is preferably an epitaxial film.

The lithium niobate film is, for example, a lithium niobate film subjected to the c-axis orientation. The lithium niobate film is, for example, an epitaxial film epitaxially grown on the substrate 2. The epitaxial film is a single-crystal film whose crystal orientation is aligned by the underlying substrate. The epitaxial film is a film having a single-crystal orientation in the z-direction and the xy-plane direction and the crystals are aligned and oriented in the x-axis, y-axis, and z-axis directions. Whether or not the film formed on the substrate 2 is an epitaxial film can be proved, for example, by confirming a peak intensity and an extreme point at an orientation position in 2θ-θ X-ray diffraction.

The optical waveguide layer 3 includes a plurality of flat portions 31 and a ridge portion 32 having a shape arranged between adjacent flat portions 31 and raised in a strip shape from the flat portion 31. In the optical modulator 1 of the present embodiment, an input waveguide 32a, an optical demultiplexing portion 4a, a first ridge waveguide 32c demultiplexed from the input waveguide 32a, a second ridge waveguide 32b, an optical multiplexing portion 4b to which they are coupled, and an output waveguide 32d to be described below are collectively referred to as one ridge portion 32.

The number n of ridge portions 32 is an integer of 2 or more. In FIG. 1, an example in which the number n of ridge portions 32 is three (n=3) is shown. Visible light having different wavelengths is input to three ridge portions 32R, 32G, and 32B.

In the present embodiment, for example, red light having a peak wavelength of 610 nm or more and 750 nm or less is input to the ridge portion 32R. For example, green light having a peak wavelength of 500 nm or more and 560 nm or less is input to the ridge portion 32G. For example, blue light having a peak wavelength of 435 nm or more and 480 nm or less is input to the ridge portion 32B. Because the optical modulator 1 of the present embodiment has the three ridge portions 32R, 32G, and 32B to which red light, green light, and blue light are input, respectively, it can preferably be used, for example, for XR glasses that can display a full-color image and the like.

As shown in FIG. 1, each of the three ridge portions 32R, 32G, and 32B has the input waveguide 32a, the optical demultiplexing portion 4a, the first ridge waveguide 32c, the second ridge waveguide 32b, the optical multiplexing portion 4b, and the output waveguide 32d.

In the three ridge portions 32R, 32G, and 32B of the optical waveguide layer 3, the input waveguide 32a is, for example, substantially rectangular in a cross-sectional view, and visible light generated by a light source such as a laser element is input. As shown in FIG. 1, the optical demultiplexing portion 4a demultiplexes the input waveguide 32a into the first ridge waveguide 32c and the second ridge waveguide 32b. The first ridge waveguide 32c and the second ridge waveguide 32b are, for example, trapezoidal in the cross-sectional view as shown in FIG. 2. The first ridge waveguide 32c and the second ridge waveguide 32b in the present embodiment have the same shape in the cross-sectional view. As shown in FIG. 1, the first ridge waveguide 32c and the second ridge waveguide 32b are multiplexed by the optical multiplexing portion 4b to form the output waveguide 32d. The output waveguide 32d is, for example, substantially rectangular in the cross-sectional view, and outputs a visible light signal generated by the optical multiplexing portion 4b.

The cross-sectional shapes of the input waveguide 32a and the output waveguide 32d are not limited to rectangular shapes and may be, for example, trapezoidal shapes or semicircular shapes.

Moreover, the cross-sectional shapes of the first ridge waveguide 32c and the second ridge waveguide 32b are not limited to trapezoidal shapes, and may be, for example, rectangular shapes or semicircular shapes.

Moreover, the cross-sectional shapes of the input waveguide 32a, the output waveguide 32d, the first ridge waveguide 32c, and the second ridge waveguide 32b may have symmetry or may not have symmetry.

When the optical modulator of the present embodiment is used as a glasses-type image display device, a thickness (T_{slab}) of the flat portion 31 of the optical waveguide layer 3 is preferably 0.1 to 0.3 μm and a thickness (T_{R}) of the ridge portion 32 of the optical waveguide layer 3 is preferably 0.5 to 1.0 μm.

This is because light does not propagate when the thickness (T_{R}) of the ridge portion 32 is small and propagated light becomes multimode light when the thickness (T_{R}) of the ridge portion 32 is large.

When the optical modulator of the present embodiment is used in a glasses-type image display device, a distance (S) between the ridge portions 32 is preferably 2 to 12 μm.

This is because when S is reduced, the distance between the signal electrode and the ground electrode can be shortened and the electric field efficiency given to the ridge portion 32 can be increased.

The ridge portion 32 shown in FIG. 2 is an example of a trapezoidal shape symmetrical with respect to the centerlines L_{1C} and L_{2C}.

When the optical modulator of the present embodiment is used in a glasses-type image display device, the inclination angle (α) of the ridge portion 32 is preferably 60 to 90 degrees in the example of this shape. This is because as the inclination angle decreases, the propagated light becomes multimode light.

Moreover, the width (W_{R}) of the upper surface of the ridge portion 32 is preferably 0.3 to 1.2 μm.

This is because the light does not propagate if the waveguide width is small and the propagated light becomes multimode light if the waveguide width is large.

### (Protective Layer 51)

As shown in FIG. 2, a protective layer 51 is arranged between the flat portion 31 of the optical waveguide layer 3 and the buffer layer 52. The protective layer 51 is made of a dielectric having a lower refractive index than the optical waveguide layer 3. As the material of the protective layer 51, for example, silicon oxide (SiO₂), aluminum oxide (Al₂O₃), lanthanum oxide (La₂O₃), a composite of these oxides, or the like can be used. Examples of the composite of the oxide include LaAlSiInO and the like. As the material of the protective layer 51, it is preferable to use silicon oxide (SiO₂) among the above oxides.

### (Buffer Layer 52)

The buffer layer 52 is formed on the optical waveguide layer 3 and the protective layer 51 to prevent visible light propagating through the optical waveguide layer 3 from being absorbed by the electrode layer 6.

The buffer layer 52 is made of a dielectric having a smaller refractive index than the optical waveguide layer 3.

The dielectric constituting the buffer layer 52 preferably has a dielectric constant of 7 or more. This is because the electric field efficiency VπL can be reduced.

Examples of specific materials of the buffer layer 52 are aluminum oxide (Al₂O₃) (having a dielectric constant of 7) and LaAlSiInO (having a dielectric constant of 11).

The material of the buffer layer 52 may be the same as or different from that of the protective layer 51.

A thickness (T_{buffer}) of the buffer layer 52 is preferably 0.4 μm or more and 1 μm or less. This is because the electric field efficiency VπL can be reduced.

### (Electrode Layer 6)

The electrode layer 6 is formed on the buffer layer 52 and includes one signal electrode 62 and a first ground electrode 61A and a second ground electrode 61B arranged on both sides of the signal electrode 62.

The optical modulator of the present embodiment is a so-called single-drive optical modulator having one signal electrode. A so-called dual-drive optical modulator having two signal electrodes has a complex electrode structure and has a problem that a circuit configuration of a drive system becomes complicated because it is necessary to apply a phase of an inverted electrical signal of data to the two signal electrodes while performing a phase control process. Because the optical modulator of the present embodiment is of a single drive type, there is no such problem.

When the optical modulator of the present embodiment is used in a glasses-type image display device, the width (Wₑ) of the signal electrode 62 is preferably 1.0 to 4.0 μm.

This is because the electric field efficiency VπL can be reduced.

When the optical modulator of the present embodiment is used in a glasses-type image display device, the widths of the first ground electrode 61A and the second ground electrode 61B are preferably 50 to 1000 μm.

This is because if the ground electrode is thin, the voltage will not be 0 V and the electric field efficiency VπL will increase.

When the optical modulator of the present embodiment is used in a glasses-type image display device, a thickness (Tₑ) of the electrode layer 6 is preferably 0.1 to 5 μm.

This is because microwaves propagate more efficiently when a modulation frequency is high and a cross-sectional area of the electrode is large.

When the optical modulator of the present embodiment is used in a glasses-type image display device, a distance (G) between the signal electrode 62 and the ground electrode 61 is preferably 1 to 12 μm.

This is because the electric field efficiency VπL can be reduced.

### (Positional Relationship Between Electrode and Ridge Waveguide)

The signal electrode 62 is above the first ridge waveguide 32c (in a direction parallel to the Z-direction) and is arranged in a positional relationship in which a distance D_{CC} in a horizontal direction (a direction parallel to the Y-direction) between the center of the signal electrode 62 in a width direction (a centerline L_{SC} passing through the center of the signal electrode 62 in the width direction and extending in the Z-direction) and the center of the first ridge waveguide 32c in the width direction (a centerline L_{1C} passing through the center of the first ridge waveguide 32c in the width direction and extending in the Z-direction) is 0.5 μm or less. An inter-center distance D_{CC} may be referred to as a relative shift.

In a configuration in which a relative positional relationship between the signal electrode 62 and the first ridge waveguide 32c is 0.5 μm or less in the relative shift D_{CC} between the signal electrode 62 and the first ridge waveguide 32c, the first ridge waveguide 32c is arranged in a range where the electric field strength is large and the electric field efficiency VπL is reduced.

Moreover, the relative shift D_{CC} is allowed, and therefore the difficulty in manufacturing is reduced and mass production is facilitated.

In FIG. 2, at a relative position (an inter-center shift) between the signal electrode 62 and the first ridge waveguide 32c, the centerline L_{SC} of the first ridge waveguide 32c is shifted to the left with respect to the centerline L_{1C} of the signal electrode 62. In FIG. 2, an example in which the first ground electrode 61A and the second ground electrode 61B are also shifted to the left like the signal electrode 62, i.e., an example in which a shift is made so that a distance G between a side surface 62a of the signal electrode 62 and a side surface 61Ab of the first ground electrode 61A and a distance G between a side surface 62b of the signal electrode 62 and a side surface 61Ba of the second ground electrode 61B do not change, is shown.

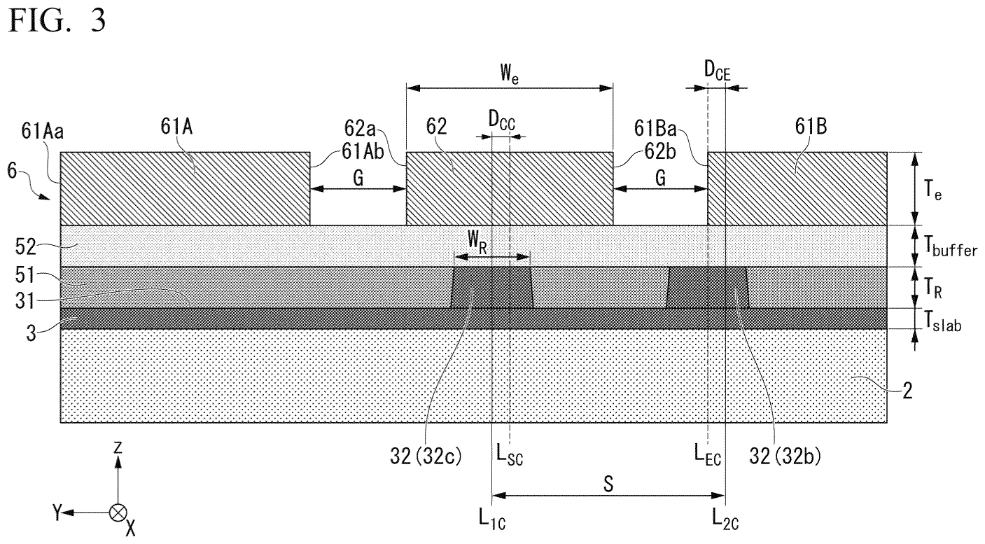

On the other hand, FIG. 3 shows a case where the centerline L_{SC} of the first ridge waveguide 32c is shifted to the right with respect to the centerline L_{1C} of the signal electrode 62.

FIG. 3 shows a case where a relative position (an inter-center shift) between the signal electrode 62 and the first ridge waveguide 32c is opposite to that in the case shown in FIG. 2. For convenience, a shift between the signal electrode 62 and the first ridge waveguide 32c shown in FIG. 2 is assumed to be a positive shift and a shift between the signal electrode 62 and the first ridge waveguide 32c shown in FIG. 3 is assumed to be a negative shift. The positive or negative shift is indicated by the sign of “−1 μm to +1 μm” in the center distance (D_{CC}) between the signal electrode 62 and the ridge portion to be described below.

The second ground electrode 61B is above the second ridge waveguide 32b (in the Z-direction) and a distance D_{CE} in the horizontal direction (the direction parallel to the Y-direction) between the side surface 61Ba on the side close to the second ridge waveguide 32b between the two side surfaces of the second ground electrode 61B and the center of the second ridge waveguide 32b in the width direction (a centerline L_{2C} passing through the center of the second ridge waveguide 32b in the width direction and extending in the Z-direction) is 2 μm or less.

In a plan view in the Z-direction, the second ground electrode 61B is arranged at a position where at least a part of the second ground electrode 61B overlaps the second ridge waveguide 32b.

### (Simulation)

VπL was used as an index for evaluating miniaturization and a low drive voltage. Vπ denotes a voltage required for half-wavelength phase modulation (a half-wavelength voltage) and is defined by a difference between a voltage V1 at which the optical output is maximized and a voltage V2 at which the optical output is minimized and the voltage Vπ is a drive voltage. Moreover, L denotes a length of the phase modulation region (an interaction length or an electrode length). A smaller VπL indicates a smaller size and a lower drive voltage.

For the simulation, a finite difference method (FDM) solver of Photon Design's FIMMWAVE was used to calculate the optical transmission efficiency and Ansys Maxwell was used to calculate VπL.

In the simulation, a model having a configuration as shown in FIGS. 1 and 2 was used and the materials of each member forming the optical modulator 1 are shown below.

The substrate 2 is a sapphire single-crystal substrate, the optical waveguide layer 3 is a lithium niobate film directly epitaxially grown on the sapphire single-crystal substrate, the protective layer 51 is silicon dioxide (SiO₂), the buffer layer 52 is LaAlSiInO, and the electrode layer 6 is made of gold.

In the simulation, the dimensions of each portion are shown below.

Thickness (T_{slab}) of the flat portion 31 of the optical waveguide layer 3: 0.15 μm

The shape of the ridge portion 32 is symmetrical with respect to the centerlines L_{1C} and L_{2C}.

Thickness (T_{R}) of the ridge portion 32: 0.7 μm

Width (W_{R}) of the upper surface of the ridge portion 32: 0.8 μm

Inclination angle (α) of the ridge portion 32: 80°

Distance (S) between the ridge portions 32: 4 μm

Thickness (T_{buffer}) of the buffer layer 52: 0.7 μm

Thickness (Tₑ) of the electrode layer 6: 2 μm

Width (Wₑ) of the signal electrode 62: 1 μm, 2 μm, 3 μm

Distance (G) between the signal electrode 62 and the ground electrode 61: 2 μm

Center distance (D_{CC}) between signal electrode 62 and ridge portion: −1 μm to +1 μm

Center distance (D_{CE}) between the second ground electrode 61B and the ridge portion: 0 to 2 μm

A shift in which the sign of “−1 μm to +1 μm” in the inter-center distance (D_{CC}) between the signal electrode 62 and the ridge portion is positive is the shift shown in FIG. 2 and a shift in which the sign is negative is a shift shown in FIG. 3.

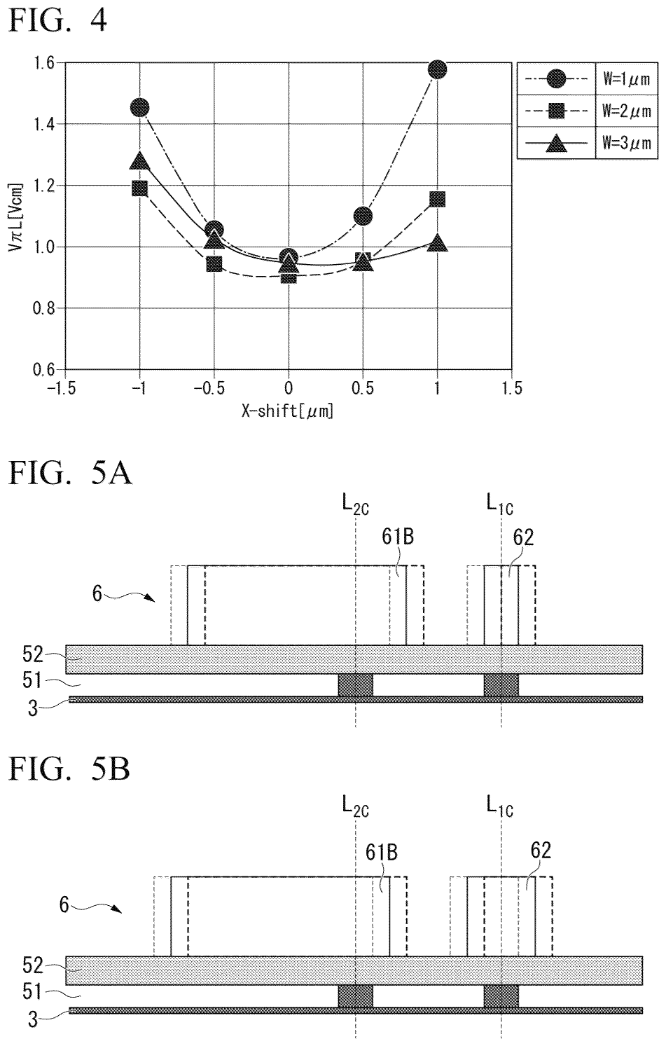

FIG. 4 is a graph showing a relationship between the inter-center distance (D_{CC}) between the signal electrode 62 and the first ridge waveguide 32c and the electric field efficiency VπL obtained by simulating red light having a wavelength of 638 nm in each of configurations in which the width (We) of the signal electrode 62 is 1 μm, 2 μm, and 3 μm.

From the graph shown in FIG. 4, in the cases of Wₑ=1 μm, 2 μm, and 3 μm, the range of the field efficiency VπL in a range of −0.5 μm to +0.5 μm with a relative shift D_{CC} is as follows;
When Wₑ=1 μm: 0.98 [Vcm]≤VπL≤1.13 [Vcm]
When Wₑ=2 μm: 0.95 [Vcm]≤VπL≤1.02 [Vcm]
When Wₑ=3 μm: 0.92 [Vcm]≤VπL≤0.96 [Vcm]

When a minimum value of the electric field efficiency VπL is VπL(min) and a maximum value of the electric field efficiency VπL is VπL(max) in a range in which the relative shift D_{CC} is −0.5 μm to +0.5 μm, a fluctuation range ({VπL(max)/VπL(min)}×100) [%] is as follows in the cases of Wₑ=1 μm, 2 μm, and 3 μm;
When Wₑ=1 μm: 15%
When Wₑ=2 μm: 7%
When Wₑ=3 μm: 4%

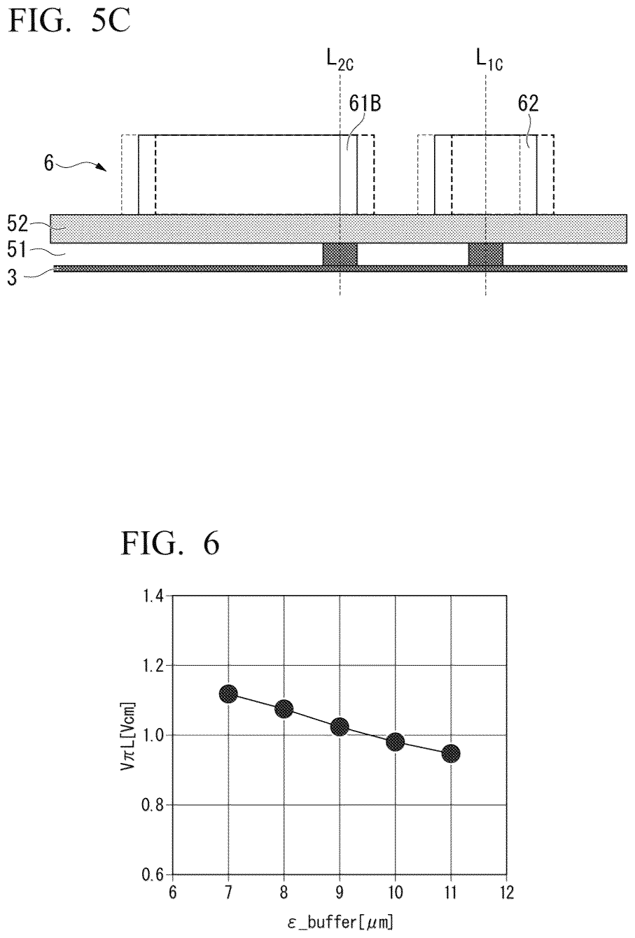

FIGS. 5A to 5C are diagrams in which configurations of cases where the inter-center distance (Doc) between the signal electrode 62 and the first ridge waveguide 32c is −0.5 μm, 0 μm, and +0.5 μm are depicted in an overlapping manner in the configurations in which the width (Wₑ) of the signal electrode 62 is 1 μm, 2 μm, and 3 μm. The inter-center distance D_{CC} may be referred to as a relative shift. For the signal electrode 62, a solid line is depicted when the relative shift D_{CC} is 0 μm, and a dashed line is depicted when the relative shift D_{CC} is −0.5 μm and +0.5 μm.

FIG. 6 is a graph showing a relationship between the dielectric constant of the dielectric constituting the buffer layer 52 and the electric field efficiency VπL obtained by simulating red light having a wavelength of 638 nm when the width (Wₑ) of the signal electrode 62 is 3 μm.

From the graph of FIG. 6, it can be seen that the electric field efficiency VπL decreases as the dielectric constant increases from 7 to 11.

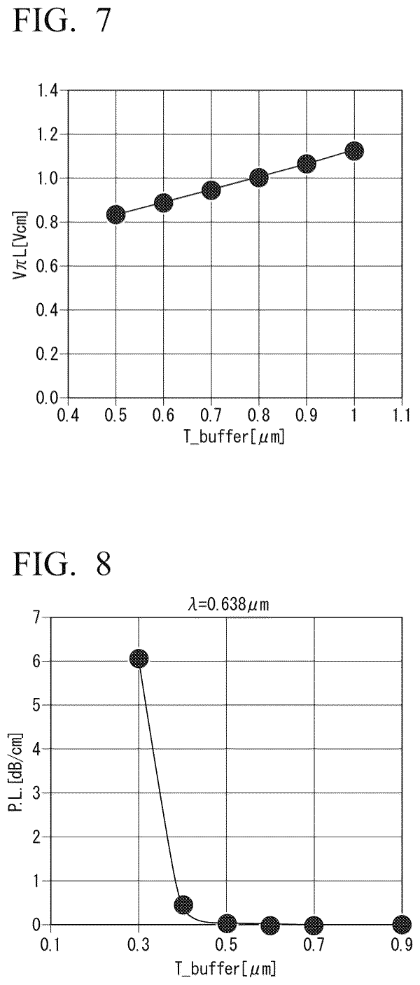

FIG. 7 is a graph showing a relationship between the thickness (T_{buffer}) of the buffer layer 52 and the electric field efficiency VπL obtained by simulating red light having a wavelength of 638 nm when the width (Wₑ) of the signal electrode 62 is 3 μm.

From the graph of FIG. 7, it can be seen that the electric field efficiency VπL decreases as the thickness of the buffer layer 52 becomes thinner from 1 μm to 0.5 μm.

FIG. 8 is a graph showing a relationship between the thickness (T_{buffer}) of the buffer layer 52 obtained by simulating red light having a wavelength of 638 nm when the width (Wₑ) of the signal electrode 62 is 3 μm and propagation loss (PL) due to light absorption by the electrode.

From the graph of FIG. 8, it can be seen that when the thickness of the buffer layer 52 becomes thinner than 0.4 μm, the propagation loss (PL) increases.

### [Light Source Module]

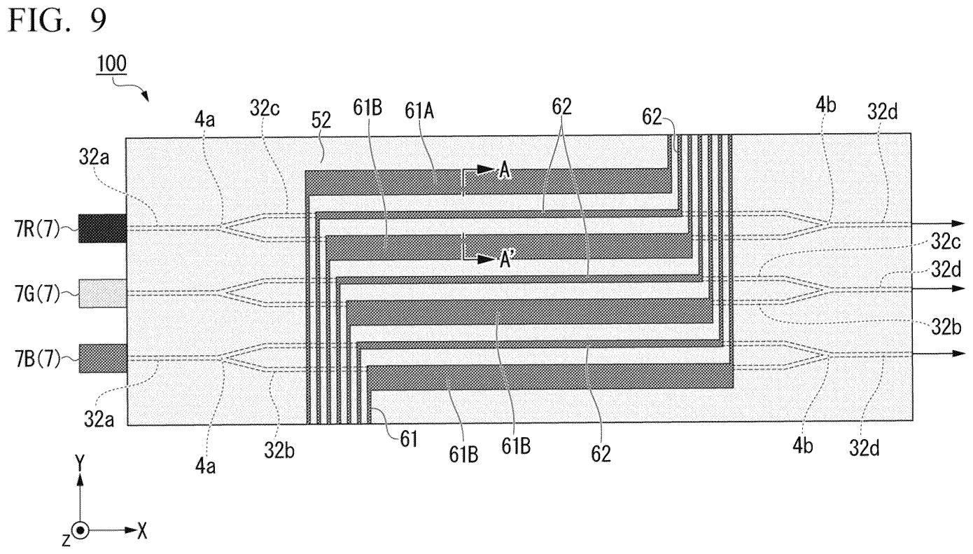

FIG. 9 shows a schematic plan view of a light source module according to an embodiment of the present disclosure.

The light source module includes an optical modulator according to the above embodiment and a light source configured to output visible light to be input to the input waveguide of the optical modulator.

A light source module 100 shown in FIG. 9 includes three light sources 7R, 7G, and 7B as a light source 7. The light sources 7R, 7G, and 7B output visible light to be input to the input waveguides 32a having the ridge portions 32R, 32G, and 32B in the optical waveguide layer 3 of the optical modulator 14. For example, the light source 7R can emit red light, the light source 7G can emit green light, and the light source 7B can emit blue light. Moreover, regardless of the arrangement of the light source of each color, for example, the light source 7B may be connected to the input waveguide 32a at the center and the light source 7R and the light source 7G may be connected to the input waveguides 32a at both ends.

As the light sources 7R, 7G, and 7B, laser elements such as laser diodes (LDs) can be used, and various types of laser elements that are commercially available can be used.

FIG. 10 is a schematic cross-sectional view in which a part of the light source module 100 shown in FIG. 9 is cut on the XZ plane. Only a part near a junction portion is depicted.

The light source 7 is installed on an upper surface of a light source base 20. The light source base 20 may be common to all light sources or may be individual for each light source.

The light source base 20 is made of, for example, aluminum nitride (AlN), aluminum oxide (Al₂O₃), silicon (Si), or the like.

The light source base 20 and the optical waveguide substrate 2 on which the optical waveguide layer is formed can be directly bonded via a metallic layer 70. With this configuration, further miniaturization is possible because there is no need for spatial coupling or fiber coupling.

By adopting a configuration in which the junction surface 20A of the light source base 20 and the junction surface 2A of the substrate 2 for the optical waveguide are bonded via the metallic layer 70, the alignment of the optical axis position of the laser beam can be performed (active alignment) so that a relative position between the light source base 20 and the optical waveguide substrate 2 is adjusted at the time of manufacture and the optical axis of each light source 7 matches the axis of the input waveguide

The metallic layer 70 can be made of a plurality of metallic layers.

When the light source module of the present embodiment is used for the XR glasses, a gap (interval) S between the junction surface 20A of the light source base 20 and the junction surface 2A of the substrate 2 for the light guide is, for example, preferably greater than 0 μm and less than or equal to 5 μm, on the basis of an amount of light required by the XR glasses and the like.

### (Drive Method)

The optical modulator can modulate the input light to the output light using a high-frequency modulation voltage and a direction current (DC) bias voltage. By controlling the DC bias voltage Vdc, the operating point Vd of the optical modulator is adjusted. The operating point Vd is a voltage that becomes a center of a modulation voltage amplitude Vₚₚ. A half-wavelength voltage of the high-frequency modulation voltage is set to Vπ(RF).

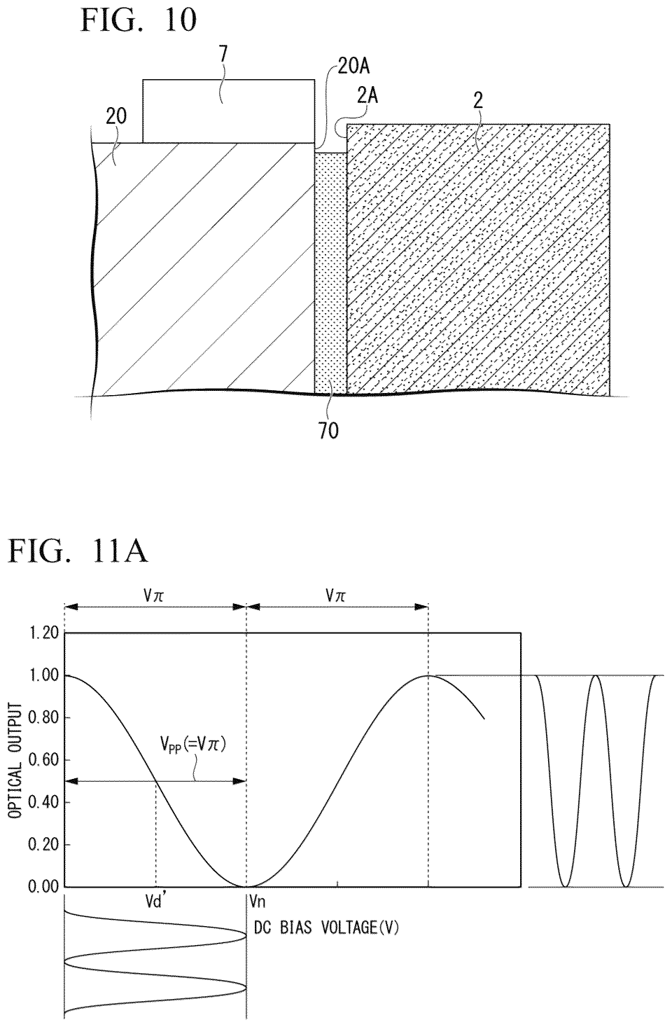

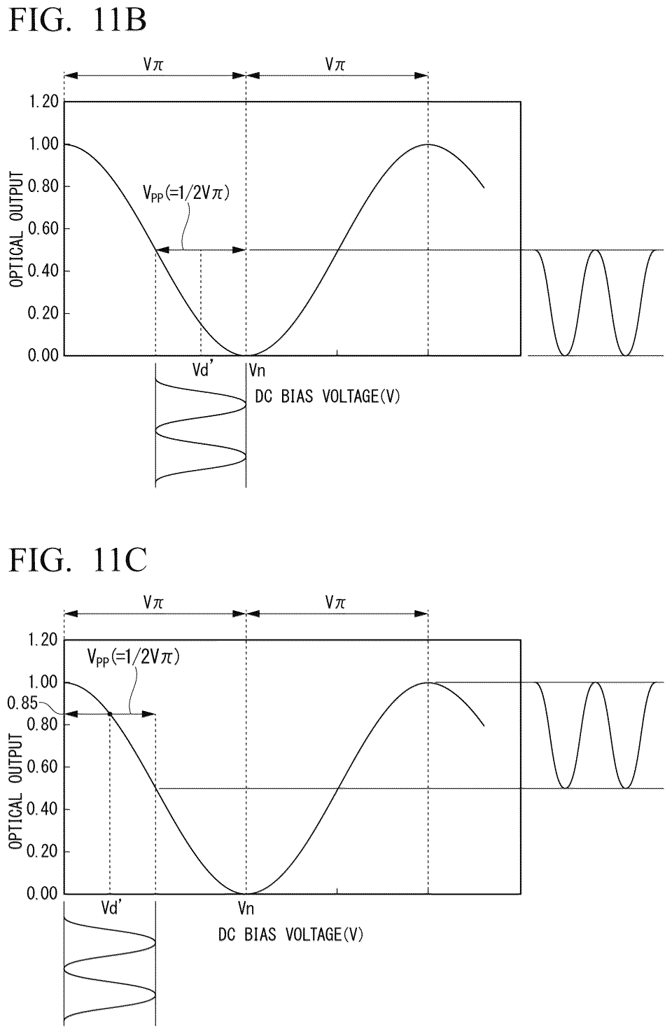

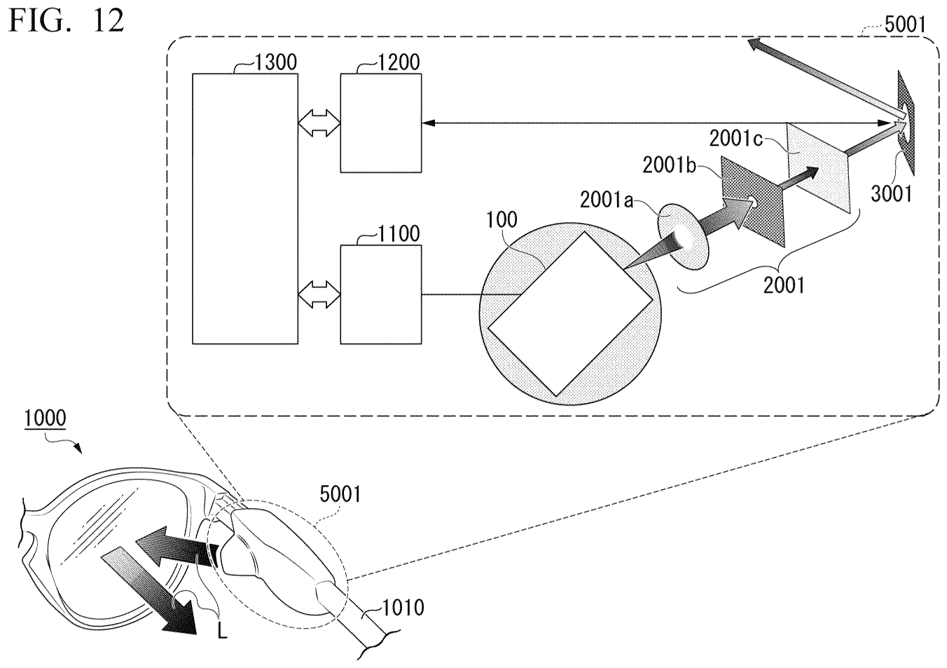

FIGS. 11A to 11C are explanatory diagrams showing three examples of a drive method for an optical modulator.

In FIGS. 11A to 11C, the horizontal axis represents a DC bias voltage applied to the optical modulator and the vertical axis represents an intensity of an optical output at the applied voltage. An applied voltage width Vₚₚ is a difference between a minimum value (Vmin) and a maximum value (Vmax) of the applied voltage.

In FIG. 11A, an example in which if the operating point Vd′ is set so that an amount of shift of the operating point voltage is (Vn-0.5 Vπ), the DC bias voltage can be set to approximately 0 V is shown. For example, when the applied voltage width Vₚₚ of the modulation voltage Vm is a half-wavelength voltage Vπ(RF), a modulation voltage Vm in a range of (−½)Vπ(RF) to (½)Vπ(RF) is applied to the optical modulator. As shown in FIG. 11A, the optical output from the optical modulator is maximized when the modulation voltage Vm is (−½)Vπ(RF) and minimized when the modulation voltage Vm is (½)Vπ(RF) and the optical output when the modulation voltage Vm is 0 V is 50% of the maximum output.

Likewise, an optical modulation process of the optical modulator in which the operating point Vd′ is set so that the amount of shift of the operating point voltage is (Vn−0.25 Vπ) and the applied voltage width Vₚₚ of the modulation voltage Vm is controlled as (¼) wavelength voltage (½)Vπ(RF) will be described with reference to FIG. 11B.

In this case, if the shift amount of the operating point voltage is set to (Vn−0.25Vπ), the operating point Vd′ can be set to the DC bias voltage of approximately 0 (V). A modulation voltage Vm corresponding to the range of (−¼)Vπ(RF) to (¼)Vπ(RF) is applied to the optical modulator. As shown in FIG. 11B, the optical output from the optical modulator is maximized when the modulation voltage Vm is (−¼)Vπ(RF) and minimized when the modulation voltage Vm is (¼)Vπ(RF) and the optical output is 15% of a maximum output when the modulation voltage Vm is 0 V (Vd′).

Likewise, an optical modulation process of the optical modulator in which the operating point Vd′ is set so that the amount of shift of the operating point voltage is (Vn−0.75 Vπ) and the applied voltage width Vₚₚ of the modulation voltage Vm is controlled as (¼) wavelength voltage (½)Vπ(RF) will be described with reference to FIG. 11C.

In this case, if the shift amount of the operating point voltage is set to (Vn−0.75Vπ), the operating point Vd′ can be set to the DC bias voltage of approximately 0 (V). A modulation voltage Vm corresponding to the range of (−¼)Vπ(RF) to (¼)Vπ(RF) is applied to the optical modulator. As shown in FIG. 11C, the optical output from the optical modulator is maximized when the modulation voltage Vm is (−¼)Vπ(RF) and minimized when the modulation voltage Vm is (¼)Vπ(RF) and the optical output is 85% of a maximum output when the modulation voltage Vm is 0 V (Vd′).

### [Optical Engine and XR Glasses]

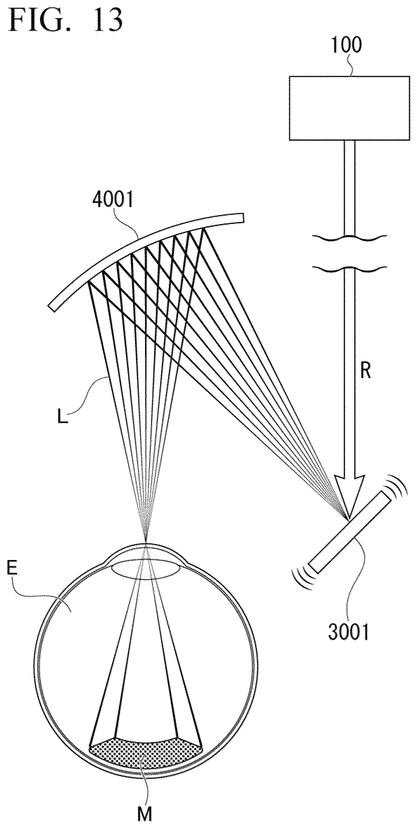

FIG. 12 is a conceptual diagram for describing an example of XR glasses of the present disclosure. FIG. 13 is a conceptual diagram showing a state in which an image is projected directly onto a retina by laser light output from the light source module in the XR glasses shown in FIG. 12.

XR glasses (glasses) 1000 of the present embodiment are a glasses-type terminal. XR is a general term for virtual reality (VR), augmented reality (AR), and mixed reality. Reference sign L shown in FIG. 13 denotes image display light.

In the XR glasses 1000 of the present embodiment shown in FIG. 12, a light source module 100 according to the above-described embodiment is mounted on an optical engine 5001 installed in a frame 1010.

As shown in FIG. 12, the optical engine 5001 includes the light source module 100, an optical scanning mirror 3001, an optical system 2001 for connecting the light source module 100 and the optical scanning mirror 3001, a laser driver 1100, an optical scanning mirror driver 1200, and a video controller 1300 that controls these drivers.

As the optical scanning mirror 3001, for example, a MEMS mirror can be used. In order to project a 2D image, it is preferable to use a 2-axis MEMS mirror that vibrates to reflect laser light by changing angles in a horizontal direction (X-direction) and a vertical direction (Y-direction) as the optical scanning mirror 3001.

The optical system 2001 optically processes laser light emitted from the light source module 100. As the optical system 2001, for example, one having a collimator lens 2001a, a slit 2001b, and an ND filter 2001c can be used. The optical system 2001 shown in FIG. 12 is an example and may have other configurations.

In the XR glasses 1000 of an embodiment shown in FIG. 12, as shown in FIG. 13, laser light R emitted from the light source module 100 attached to the frame 1010 is reflected by the optical scanning mirror 3001 and is further reflected by a lens 4001 of the XR glasses 1000. The laser light R enters an eyeball E of a person as image display light L and it is possible to directly project an image (video) onto a retina M.

Because the XR glasses 1000 of the present embodiment are equipped with the light source module 100 of the present embodiment, electric field efficiency is reduced.

Although embodiments of the present disclosure have been described in detail with reference to the drawings, configurations in the embodiments and combinations thereof are examples and the addition of, omission, replacement, and other changes of configurations are possible without departing from the spirit of the present disclosure.

For example, it is only necessary for the number of ridge portions provided in the optical waveguide layer of the optical modulator of the present disclosure to be two or more, and it is not limited to three or four.

### EXPLANATION OF REFERENCES

1 Optical Modulator
2 Substrate
3 Optical waveguide layer
32 Ridge portion
32b Second ridge waveguide
32c First ridge waveguide
52 Buffer layer
61 Ground electrode
61A First ground electrode
61B Second ground electrode
62 Signal electrodes
100 Light source module

1. An optical modulator comprising:
a substrate;
an optical waveguide layer formed on the substrate, having a Mach-Zehnder waveguide including a first ridge waveguide and a second ridge waveguide propagating visible light, and made of lithium niobate;
a buffer layer formed on the optical waveguide layer;
a signal electrode formed on the buffer layer; and
a first ground electrode and a second ground electrode arranged on both sides of the signal electrode,
wherein the signal electrode is arranged above the first ridge waveguide,
wherein the second ground electrode is arranged above the second ridge waveguide,
wherein the signal electrode and the first ridge waveguide are arranged to be relatively shifted so that a distance in a horizontal direction between a center of the signal electrode in a width direction and a center of the first ridge waveguide in the width direction is 0.5 μm or less, and
wherein the second ground electrode and the second ridge waveguide are arranged so that a distance in the horizontal direction between a side surface closer to the second ridge waveguide between two side surfaces of the second ground electrode and a center of the second ridge waveguide in the width direction is 2 μm or less.

2. The optical modulator according to claim 1,
wherein a dielectric constant of the buffer layer is 7 or more, and
wherein a thickness of the buffer layer is 0.4 μm or more and 1 μm or less.

3. A light source module comprising:
the optical modulator according to claim 1; and
a light source configured to output visible light to be input to the input waveguide of the optical modulator.

4. An optical engine comprising:
the light source module according to claim 3; and
an optical scanning mirror configured to reflect light output from the light source module by changing an angle so that an image is displayed.

5. XR glasses equipped with the optical engine according to claim 4.

6. A light source module comprising:
the optical modulator according to claim 2; and
a light source configured to output visible light to be input to the input waveguide of the optical modulator.

7. An optical engine comprising:
the light source module according to claim 6; and
an optical scanning mirror configured to reflect light output from the light source module by changing an angle so that an image is displayed.

8. XR glasses equipped with the optical engine according to claim 7.
